(19) United States
(12) Patent Application Publication
(10) Pub. No.: US 2006/0291865 A1
(43) Pub. Date: Dec. 28, 2006

(54) OPTICAL NETWORK

(76) Inventor: Georgios Margaritis, Los Altos, CA (US)

Correspondence Address: Georgios Margaritis, 370 Verano Drive, Los Altos, CA, 94022, US

(21) Appl. No.: 11/425,144

(22) Filed: Jun. 20, 2006

Related U.S. Application Data
(60) Provisional application No. 60/693,153, filed on Jun. 22, 2005.

(51) Int. Cl. H04B 10/00

(52) U.S. Cl. 398/135

(57) ABSTRACT

In this invention, a novel optical network is disclosed, comprising at least one base transceiver and a plurality of premise transceivers wherein the base transceiver transmits data frames and timing frames to all said premise transceivers and wherein each one of said premise transceivers receives said data and timing frames and transmits to said base transceiver a data frame when a received timing frame instructs said premise transceiver to transmit it. In another embodiment, a free space optics network comprising a plurality of base transceivers and a plurality of premise transceivers is disclosed, wherein each premise transceiver can transmit optical signals of a specific wavelength range that is in general different from the wavelength range of every other premise transceiver and wherein each base transceiver is aligned to a specific premise transceiver and includes a bandpass optical filter that only allows optical signals from said specific premise transceiver to pass through.

This application claims the benefit of U.S. Provisional Application No. 60/693,153, filed on Jun. 22, 2005.

### FIELD OF THE INVENTION

The present invention relates to the field of fiber based and free space based optical networks.

### INTRODUCTION

Communication needs are increasing at a fast pace. Optical networks, and in particular optical networks based on wavelength division multiplexing (WDM), with their large data carrying capacity, are emerging as the networks of choice for carrying network data between access points and central stations of communication providers.

However, the effort to bring more communication bandwidth through optical networks directly to consumers has met with two main problems. First, WDM based optical equipment are in general expensive and are designed to meet station to station communication needs, not station to consumer premises needs. Secondly, fiber needs to be installed that reaches the customer premises, something that is time consuming and costly.

In this patent, a novel optical network and novel associated equipment are disclosed, where a base point can send and receive optical signals to and from multiple premise points using a small number of laser wavelengths. In this manner, the present invention addresses the need to carry large bandwidth of data to the consumer by taking advantage of the large data carrying capacity of laser beams, and thus enabling servicing of a larger number of premises in a small geographical area. Further, by introducing a free space variation of this invention, the need to install fiber is largely eliminated, thereby reducing the cost to deploy optical networks reaching the consumer.

### SUMMARY OF THE INVENTION

A novel optical network is disclosed to allow quick and cost-effective high bandwidth connection of a number of premises to each other and to a central network. In one embodiment of this invention, a base transceiver transmits data and synchronization information to a plurality of premise transceivers using a specific wavelength range, and each premise transceivers transmits data back to the base transceiver when received synchronization information instructs it to do so. In this manner, all premise transceivers can use the same wavelength range to transmit data back to the base transceiver, thus saving wavelength bandwidth to be used by additional base to premise transceiver combinations. In another free space network of this inventions, a plurality of base transceivers and a plurality of premise transceivers are aligned so that each base transceiver is aligned to a specific premise transceiver, and each premise transceiver transmits optical signals of a specific wavelength range that is in general different from the wavelength range of every other premise transceiver and each base transceiver includes a bandpass optical filter that only allows optical signals from its corresponding premise transceiver to pass through. In this manner, multiple base to premise transceiver pairs can share the same free space without signal mixing.

### LIST OF FIGURES

FIG. 1 shows one embodiment of a free space optical network of this invention.

FIG. 2 shows one embodiment of a base transceiver of the free space optical network shown in FIG. 1.

FIG. 3 shows one embodiment of transmit and receive optics of the base transceiver of FIG. 2

FIG. 4 shows a block diagram of a Verilog program implemented by the base transceiver of FIG. 2.

FIG. 5 shows one embodiment of a premise transceiver of the free space optical network shown in FIG. 1.

FIG. 6 shows one embodiment of transmit and receive optics of the premise transceiver of FIG. 2

FIG. 7 shows a block diagram of a Verilog program implemented by the premise transceiver of FIG. 5.

FIG. 8 shows the fields of a timing frame of this invention employed to synchronize transmission of signals between premise transceivers

FIG. 9 shows one embodiment of a fiber based optical network of this invention.

FIG. 10 shows one embodiment of a base fiber transceiver of the fiber based optical network of FIG. 9.

FIG. 11 shows one embodiment of a premise transceiver of the fiber based optical network of FIG. 9.

### DESCRIPTION OF THE INVENTION

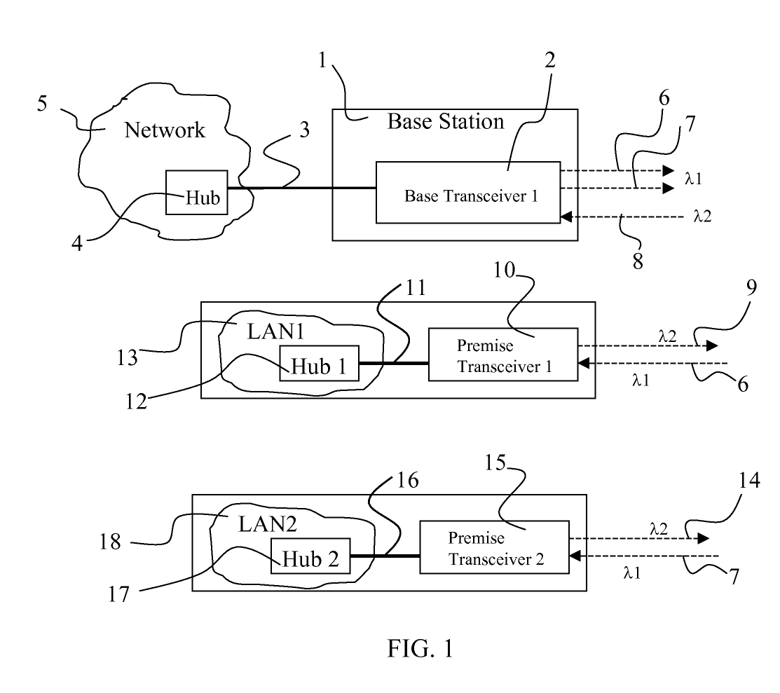

One embodiment of the network of this invention is shown in FIG. 1. It includes a base transceiver 2 located in a base station 1, such as a building or a communications tower. The transceiver 2 is connected to an Ethernet network 5, through a 1000Baset-T port of a switching hub 4, with a network grade cable 3 terminated with RJ-45 connectors. The base transceiver 2 receives data from the switching hub 4 in the form of Ethernet frames. A detailed description of the base transceiver 2 of this invention is presented later in this specification.

The base transceiver 2 converts the electrical signals received from the switching hub 4 to optical signals 6 and 7 of a specific wavelength λ₁ using a single mode laser source. The optical signals 6 and 7 produced by the transceiver 2 are transmitted through free space to reach a plurality of premise transceivers, 10 and 15. A detailed description of the premise transceivers of this invention is presented later in this specification.

The premise transceivers 10 and 15 receive the optical signals 6 and 7 respectively from the base transceiver 2, and convert it to 100Base-TX electrical signals. The signals are then sent to switching hubs, 12 and 17 using RJ-45 terminated network cables 11 and 16. The switching hubs 12 and 17 are parts of Ethernet local area networks 13 and 18.

In the reverse direction, the premise transceivers 10 and 15 receive 100Base-TX signals from the switching hubs 12 and 17. The premise transceivers 10 and 15 convert the electrical signals to optical signals 9 and 14 of a specific wavelength λ₂ using a single mode laser source and send them sequentially, frame by frame and one premise transceiver after another, to base transceiver 2. For example, premise transceiver 10 sends a frame of data to base transceiver 2 first, then premise transceiver 15 sends a frame of data to base transceiver 2 and the cycle is then repeated. The synchronization of the transmission of the premise transceivers is done by means of timing frames sent periodically by the base transceiver 2.

Base transceiver 2 receives the optical signals 9 and 14, one at a time, shown as 8 in FIG. 1, from premise transceivers 10 and 15, converts them to 1000Base-T electrical signals and sends them to the switching hub 4 to distribute to the network 5.

Although not shown explicitly in FIG. 1, free space transmission implies that there is an unobstructed optical path, direct or indirect, from the base transceiver 2 to the premise transceivers 10 and 15. Also, for simplicity and better clarity, FIG. 1 shows only two premise transceivers serviced by one base transceiver. However, this invention can be extended to a larger number of premise transceivers per base transceivers. In general, the number of premises that can be serviced by one base transceiver depends on the total bandwidth of the laser signal and the bandwidth need of each premise. For example, if a 1000 Mbit/s signal is transmitted, and each premise requires 100 Mbits/s local bandwidth, then any number of premises up to 10 premises can be serviced. In another example, if a 10 Gbit/s signal is transmitted, and each premise requires 100 Mbits/s then any number of premises up to 100 premises can be serviced. Also, in other embodiments, multiple combinations of base transceivers and premise transceivers, each combination as shown in FIG. 1, can be deployed per base station.

Also, in another embodiment, a base station can include a plurality of base transceivers each optically aligned to a corresponding premise transceiver among a plurality of premise transceivers. Each premise transceiver transmits optical signals of a specific wavelength range that is in general different from the wavelength range of every other premise transceiver. Each base transceiver includes a bandpass optical filter that only allows optical signals from the corresponding premise transceiver to pass through, thus avoiding signal mixing. Also, each base transceiver could transmit signals of specific wavelengths and each corresponding premise transceiver could include an optical filter to allow only wavelengths from the corresponding base transceiver to pass through.

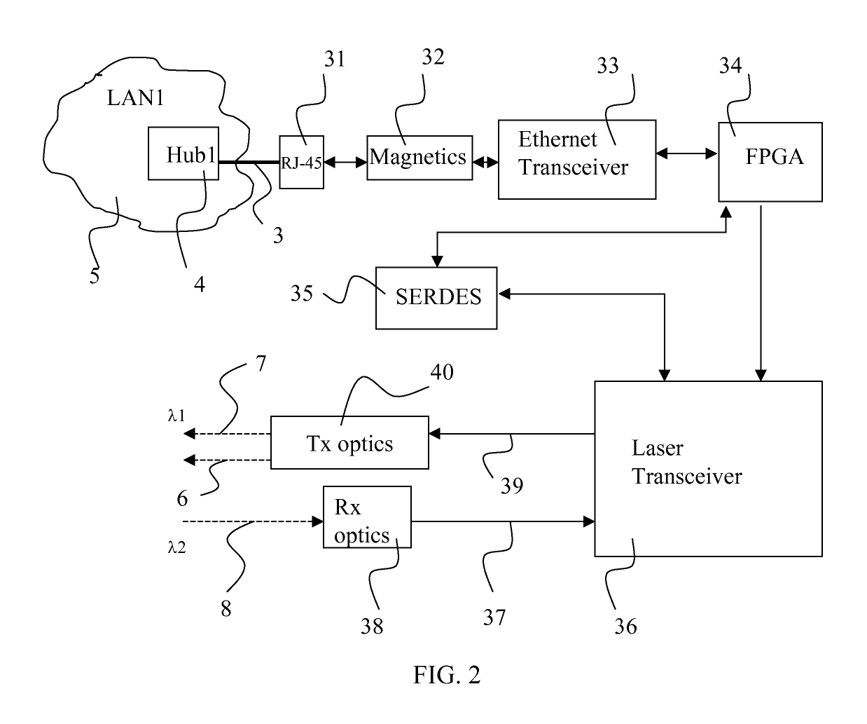

FIG. 2 shows one embodiment of the base transceiver 2 of the present invention. It includes a RJ-45 connector 31, a set of four isolation transformers 32, one for each channel of the 1000 Base-T signal, such as four Pulse H-5007, connected to the RJ-45 connector 31 and to a Gigabit Ethernet transceiver IC 33, such as a National Semiconductor DP83865DVH. The Ethernet transceiver IC 33 is connected through its GMII interface to a Field Programmable Gate Array (FPGA) 34, such as a Xilinx Virtex FPGA. The FPGA 34 is connected to a Serializer/Deserializer transceiver IC (SERDES) 35, such as a Texas Instruments TLK 1501. The SERDES 35 is connected to a single mode laser transceiver 36, such as a JDSU CT2 series transceiver. A single mode fiber 37 is connected at one end to the input of the laser transceiver 36 and coupled at the other end to receive optics 38 that receive the optical signal 8 from free space. A single mode fiber 39 is connected at one end to the output of the laser transceiver 36 and coupled at the other end to transmit optics 40 that transmit the optical signals 6 and 7 into free space.

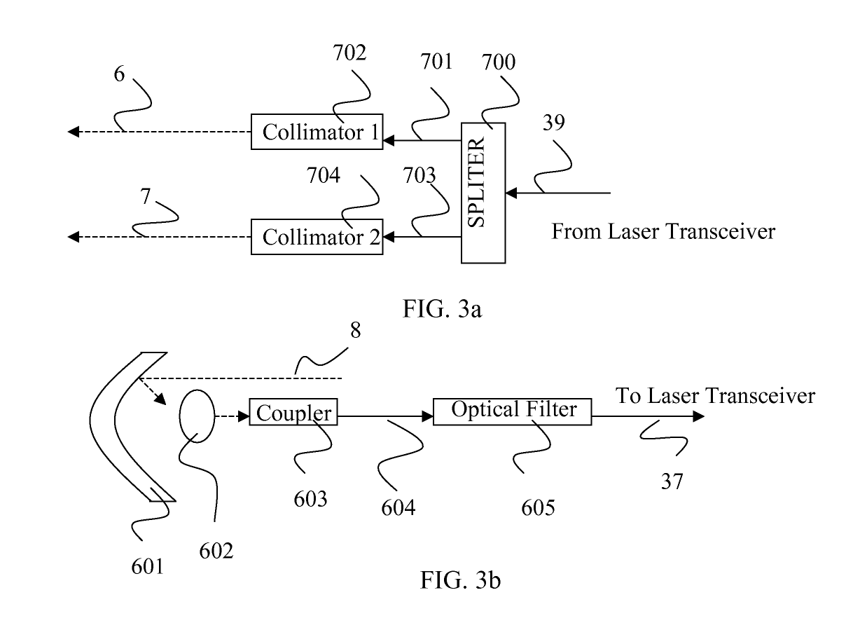

FIG. 3a shows one embodiment of the transmit optics 40 of the base transceiver 2. They include a 1×2 splitter 700, such as an FFC series splitter from JDSU that connects to fiber 39. The outputs 701 and 702 of the splitter are connected to two collimators 702 and 704, such as fiber optic collimators from Edmund Optics. The collimators emit the optical signals 6 and 7 into free space.

FIG. 3b shows one embodiment of the receive optics 38 of the base transceiver 2. They include a parabolic reflector 601, such as an Edmund Optics large parabolic reflector, that collects light from signal 8, and focuses it through a lens 602 onto a fiber optic collimator 603, such as a fiber optic collimator from Edmund Optics that connects to a fiber 604. The fiber 604 connects to the input of an optical filter 605, such as a JDSU DWS series filter. The output of optical filter 605 connects to fiber 37.

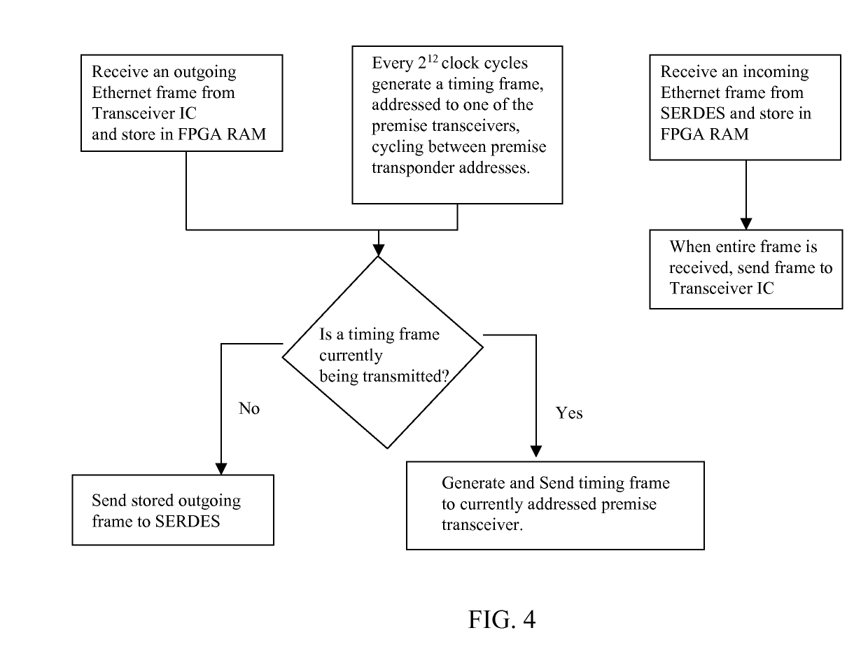

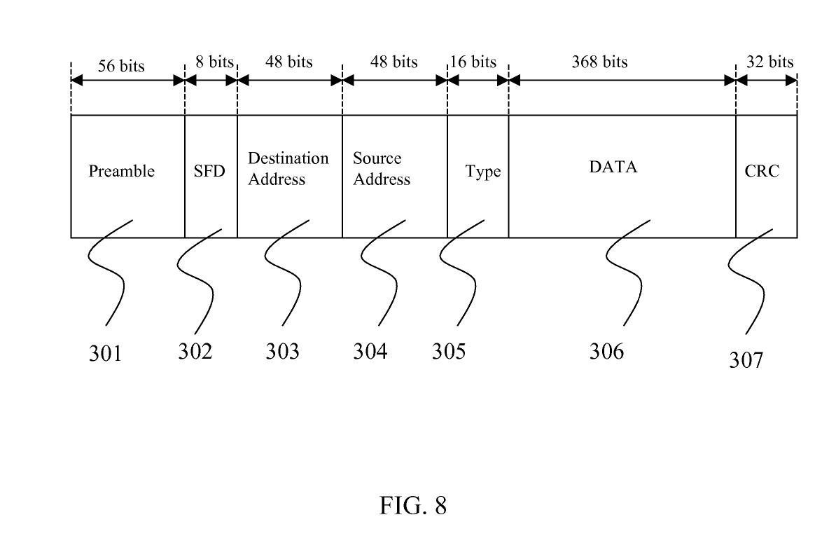

The FPGA 34 implements a Verilog program shown in a high-level block diagram form in FIG. 4. By implementing this program the FPGA accomplishes a number of functions in parallel. First, it generates a timing frame every 2¹² clock cycles. A 25 MHz clock is used. Referring to FIG. 8, the timing frame has a preamble field 301 of 56 bits of alternating 1's and 0's, identical to those of an Ethernet frame. It has a Start Frame delimiter field 302 of 8 bits, 10101011, again identical to those of an Ethernet frame. It has a destination address field 303 of 48 bits. This address is a local address recognized only by the base and premise transceivers and each premise transceiver has a unique predetermined address. For example, premise transceiver 10 of FIG. 1, can have address 1 (that is the first 47 bits of the destination Address field are 0 and the last bit is 1), and premise transceiver 15 of FIG. 1 can have address 2 (that is the first 46 bits of the destination address field are 0 and the last two bits are 1 and 0). The remainder of the fields 304 to 307 of the timing frame have the value zero (that is all bits are 0). It is noted here that the frequency at which timing frames are sent (as well as the clock frequency) can be adjusted and is not limited to 1 every 2¹² clock cycles. Also, the timing frame need not necessarily be an Ethernet frame but may have numerous other forms, as long as it can address each premise transceiver separately and can be processed by the IC logic of the premise transceivers.

In parallel, the FPGA 34, receives and stores in its RAM frames received from the Ethernet transceiver 33. It sends these frames to SERDES 35, when a timing frame is not transmitted. Also, the FPGA 34, receives and stores in its RAM frames received from the SERDES 35. It then sends these frames to Ethernet transceiver 33.

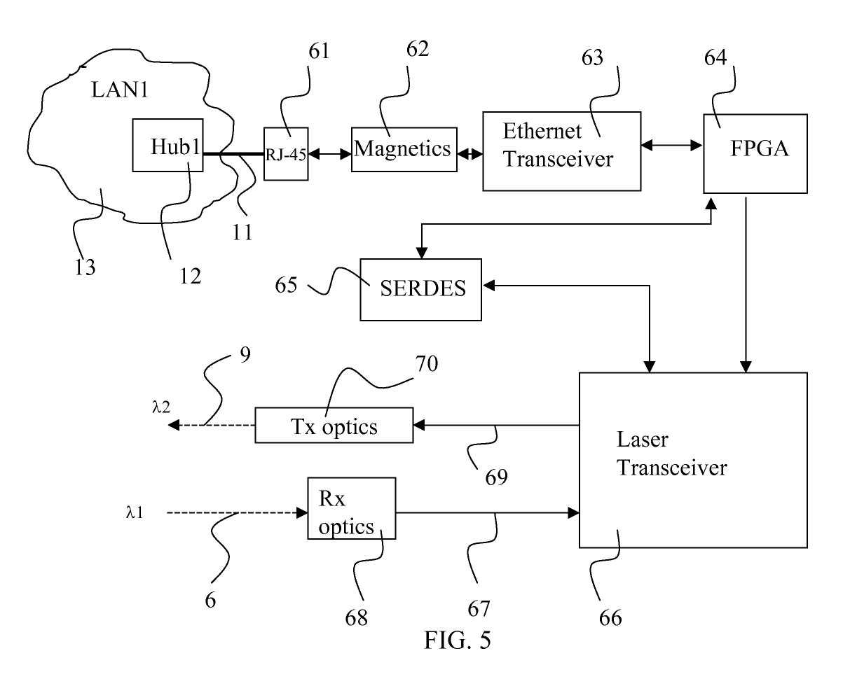

FIG. 5 shows one embodiment of the premise transceiver 10 of the present invention. Premise transceiver 15 is identical to premise transceiver 10. It includes a RJ-45 connector 61, one isolation transformer 62 such as a Pulse PE-68515L, connected to the RJ-45 connector 61 and to a Fast Ethernet transceiver IC 63, such as an Intel LXT971A. The Ethernet transceiver IC 63 is connected through its MII interface to a Field Programmable Gate Array (FPGA) 64, such as a Xilinx Virtex FPGA. The FPGA 64 is connected to a Serializer/Deserializer transceiver IC (SERDES) 65, such as a Texas Instruments TLK 1501. The SERDES 65 is connected to a single mode laser transceiver 66, such as a JDSU CT2 series transceiver. A single mode fiber 67 is connected at one end to the input of the laser transceiver 66 and coupled at the other end to receive optics 68 that receive the optical signal 6 from free space. A single mode fiber 69 is connected at one end to the output of the laser transceiver 66 and coupled at the other end to transmit optics 70 that transmit the optical signal 9 into free space.

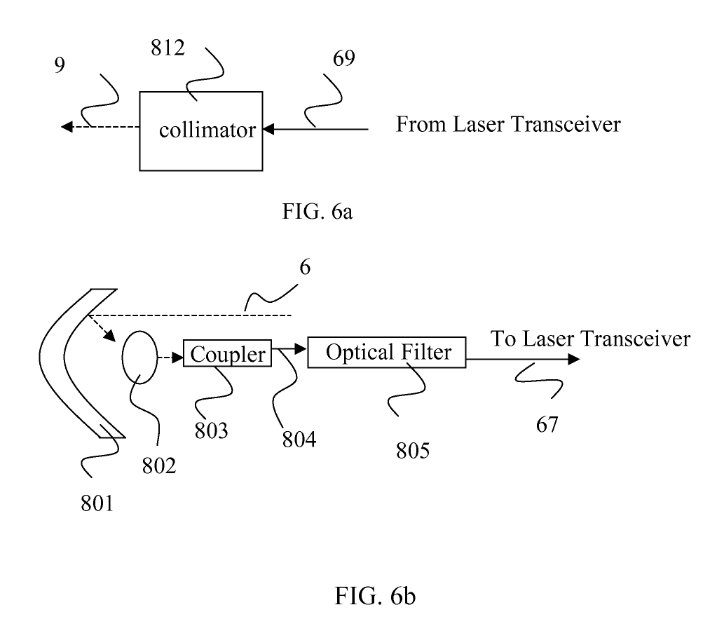

FIG. 6a shows one embodiment of the transmit optics 70 of the base transceiver 10. They include a collimator 812, such as fiber optic collimators from Edmund Optics. The collimator is connected to the laser transceiver 66 with fiber 69. The collimator emits the optical signal 9 into free space.

FIG. 6b shows one embodiment of the receive optics 68 of the premise transceiver 10. They include a parabolic reflector 801, such as an Edmund Optics large parabolic reflector, that collects light from signal 6, and focuses it through a lens 802 onto a fiber optic collimator 803, such as a fiber optic collimator from Edmund Optics that connects to a fiber 804. The fiber 804 connects to the input of an optical filter 805, such as a JDSU DWS series filter. The output of optical filter 805 connects to fiber 67.

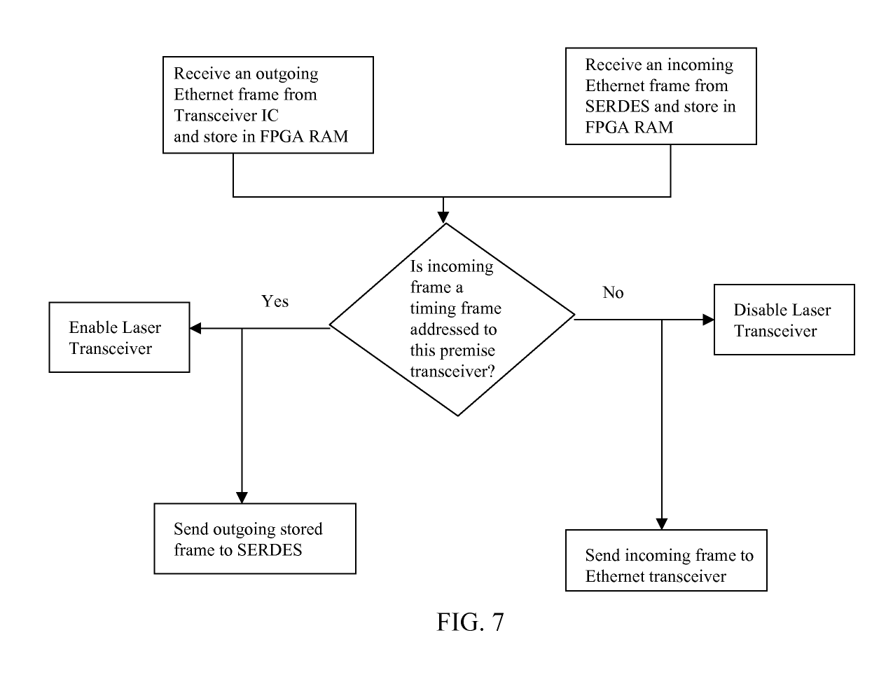

The FPGA 64 implements a Verilog program shown in high-level block diagram form in FIG. 7. The FPGA 64, receives and stores in its RAM incoming frames received from SERDES 65 and outgoing frames received from the Ethernet IC 63. It examines the incoming frames. If a frame is a timing frame (by having 0 source address, 1 destination address for premise transceiver 1, and zero every other field) it enables the laser transceiver and sends any stored outgoing frame to SERDES 65. If the incoming frame is not a timing frame, it disables the laser transmitter and sends the incoming frame to Ethernet IC 63.

Numerous other embodiments of the present invention are also possible. For example, although this embodiment uses a 1000Base-T connection to the switching hub of the base station, many other connections of different speeds or connection media are possible, such as 10-BaseT, or 100-BaseTX, or 1000Base-T connections, that use electrical interfaces, or 1000Base-X, or 10Gibabit/s connections using optical interfaces. Also, in other embodiments, the data source could be a video feed station, a cable head-end or any other source of data. Further, in other embodiments, the data frames could be in the form of SONET or ATM frames or any other type of data units or frames transmitted through a network. Also, in other embodiments, a multi-mode laser source could be used if there is no interference with other laser beams in the area. Also, the parabolic reflector of the receive optics can be replaced by a lens or system of lenses or a combination. In general, light focusing systems are well known to the Art and any of those, capable of focusing and coupling an incoming light beam into a fiber or directly to a photodetector, could be used. Also, the FPGA 34 of the base transceiver and/or the FPGA 64 of premise transceivers could be replaced by an application specific IC (ASIC) or by a DSP or CPU programmed to perform the functions of the FPGA. Many combinations of the above are also possible. Also, the Ethernet transceiver IC 33 and/or IC 63 could be replaced by an Ethernet controller IC, such as an Intel 82540EM Gigabit Ethernet controller, and the connection to FPGA 34 and/or 64, could be done by a PCI bus. Other controllers and bus types could also be used. Also, the Ethernet transceiver functions could be integrated in the FPGA.

Also, instead of timing frames, the synchronization of transmission of the premise transceivers can be accomplished by other schemes, such as an Ethernet-type collision detect and avoidance algorithm, a PCI-type or USB-type bus or line sharing algorithm. In these cases, each premise transceiver needs to have a second laser receiver, to monitor transmissions on wavelength λ₂ by other premise transceivers and start a transmission when there is no contention from other premise transceivers.

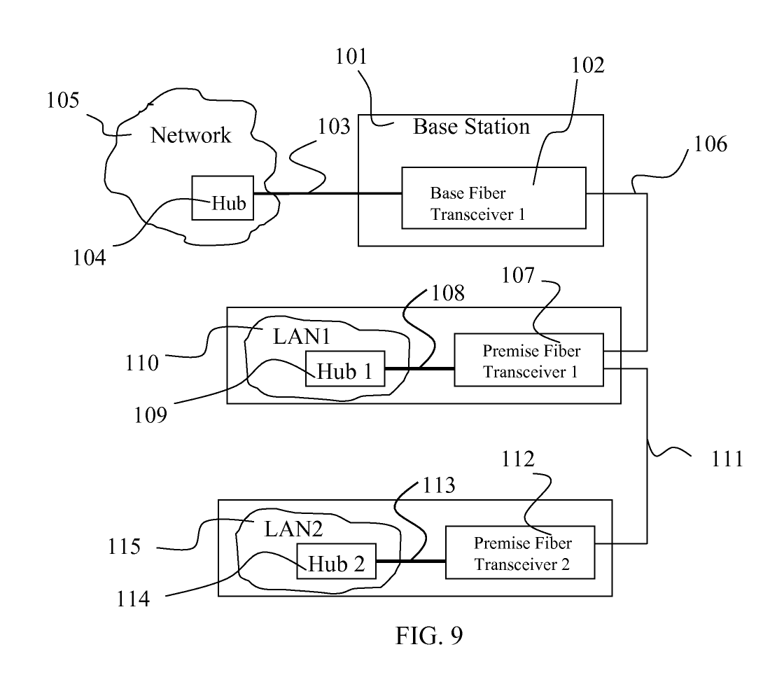

In another embodiment of the present invention, in areas where fibers have been installed, the network of this invention can be deployed using the fibers exclusively. FIGS. 9 shows an embodiment of this invention using fibers. A base fiber transceiver 102 of FIG. 9 is connected to a first premise fiber transceiver 107 with a fiber 106. Premise fiber transceiver 107 is connected to a second premise fiber transceiver 112, with a fiber 111.

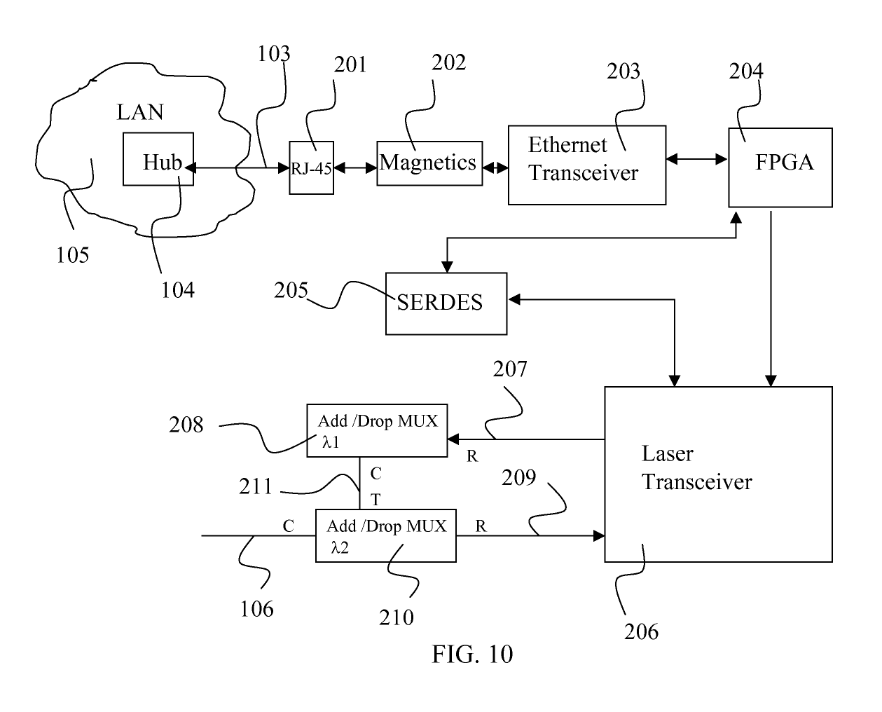

FIG. 10 shows one embodiment of the base fiber transceiver 102. Components 201 to 206 are identical to components 31 to 36 of the base transceiver of FIG. 2 with identical function and operation, including the Verilog implementation of FIG. 4. However, the receive and transmit optics sections are replaced by an optical Add/Drop Multiplexer 210, for wavelength λ2 and by an optical Add/Drop Multiplexer 208, for wavelength λ1. The common port of multiplexer 210 connects to fiber 106 and its reflect port connects to the input of laser transceiver 206, with fiber 209. The common port of multiplexer 208 connects to the transmit port of multiplexer 210 with fiber 211 and the reflect port of multiplexer 208 connects to the output of laser transceiver 206 with fiber 207. Multiplexer 210 drops the wavelength that carries the signal from the premise fiber transceivers 107 and 112 and inputs it into the laser transceiver 206. Multiplexer 207 adds the output of the laser transceiver 206 to fiber 106 to send to the premise fiber transceivers 107 and 112.

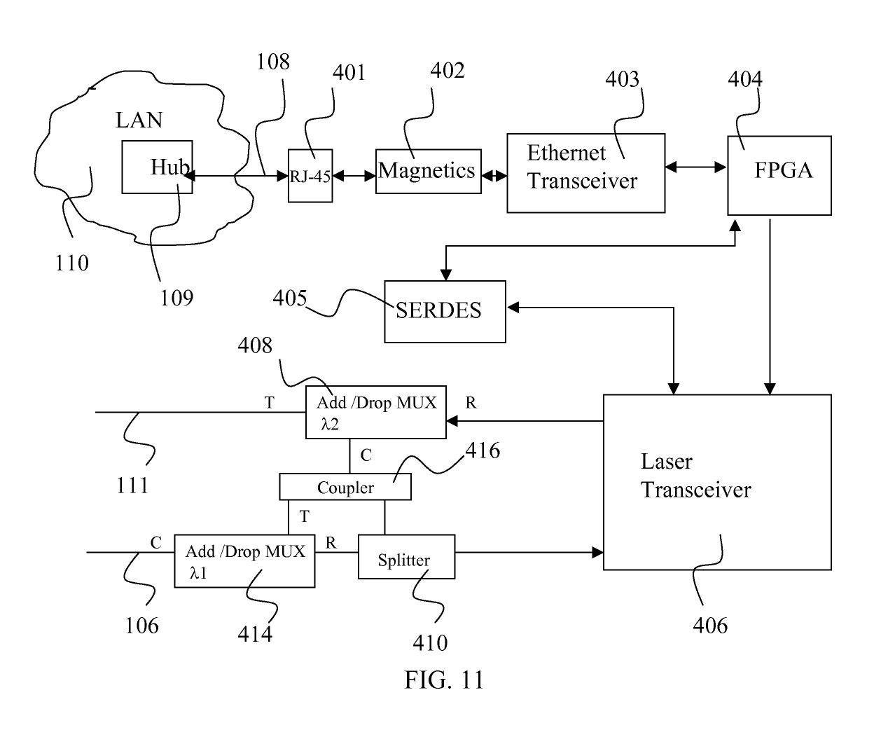

FIG. 11 shows one embodiment of the premise fiber transceiver 107. Components 401 to 406 are identical to components 61 to 66 of the base transceiver of FIG. 5 with identical function and operation, including the Verilog implementation of FIG. 7. However, the receive and transmit optics sections are replaced by an optical Add/Drop Multiplexer 408, for wavelength λ2, by an optical Add/Drop Multiplexer 414, for wavelength λ1, by a 95/5 splitter 410 and a 50/50 coupler 416. Different splitter and coupler ratios are also possible. The common port of multiplexer 414 connects to fiber 106, its reflect port connects to the input of splitter 410 and its transmit port connects to one input of coupler 416. The 5% port of splitter 210 connects to the input of laser transceiver 406 and its 95% port to an available input of coupler 416. The output of coupler 416 connects to the common port of multiplexer 408. The transmit port of multiplexer 408 connects to fiber 111 and its reflect port to the output of laser transceiver 406. This arrangement of optical components allows for a portion (5%) of the signal from the base fiber transceiver 102 to be input into the local laser transceiver 406 and the remaining signal to continue to the next premise fiber transceiver 112. Also, it allows for the output from the laser transceiver 406 to be added to fiber 106 to be sent to the base fiber transceiver 102.

I claim:

1. An optical network comprising at least one base transceiver and a plurality of premise transceivers wherein the base transceiver transmits data and synchronization information to all said premise transceivers and wherein each one of said premise transceivers receives said data and synchronization information and transmits to said base transceiver data when said synchronization information instructs said premise transceiver to transmit said data.

2. The optical network of claim 1 wherein said base transceiver and said premise transceivers exchange information through free space.

3. The optical network of claim 1 wherein said base transceiver and said premise transceivers exchange information through at least one optical fiber.

4. The network of claim 1 wherein said data are frames of a communication protocol selected from the group consisting of Ethernet, SONET and ATM.

5. The network of claim 1 wherein each one of said premise transceivers transmits optical signals of specific wavelengths.

6. The network of claim 5 wherein all premise transceivers transmit optical signals of the same wavelengths.

7. The network of claim 1 wherein said base transceiver includes means for separating incoming optical signals of multiple wavelengths into a plurality of optical signals each of specific wavelengths.

8. The network of claim 1 wherein said base transceiver includes means for selecting specific wavelengths from incoming optical signals of multiple wavelengths.

9. The network of claim 1 wherein each one of said premise transceivers includes means for selecting specific wavelengths from incoming optical signals of multiple wavelengths.

10. The network of claim 1 further comprising a plurality of base transceivers each associated with a plurality of premise transceivers.

11. The network of claim 3 wherein said base transceiver and said premise transceivers are all linked through one fiber and wherein said premise transceivers include means for allowing a portion of the signal from the base transceiver to be input into each premise transceiver and the remaining portion of the signal to continue to the next premise transceiver and means for allowing the output from each premise transceiver to be added to the fiber to be sent to the base transceiver.

12. A free space optical network comprising a plurality of base transceivers and a plurality of premise transceivers wherein each premise transceiver can transmit optical signals of specific wavelengths that are in general different from the wavelengths of the signals of every other premise transceiver and wherein each base transceiver is aligned to a specific premise transceiver and includes an optical filter that only allows optical signals from said specific premise transceiver to pass through.

13. The free space optical network of claim 12 wherein each one of said base transceivers transmits optical signals of specific wavelengths.

14. The free space optical network of claim 13 wherein each premise transceiver includes an optical filter that only allows optical signals from the corresponding base transceiver to pass through.
